(19) United States
(12) Patent Application Publication
(10) Pub. No.: US 2012/0195063 A1
(43) Pub. Date: Aug. 2, 2012

(54) BACKLIGHT ASSEMBLY AND DISPLAY APPARATUS HAVING THE SAME

(75) Inventors: Guk-Hyun KIM, Yongin-si (KR); Byoung-Ho CHEONG, Yongin-si (KR)

(73) Assignee: SAMSUNG ELECTRONICS CO., LTD., Suwon-si (KR)

(21) Appl. No.: 13/289,014

(22) Filed: Nov. 4, 2011

(30) Foreign Application Priority Data
Jan. 31, 2011 (KR) 2011-0009247

(51) Int. Cl. G09F 13/04; F21V 13/04; F21V 7/00

(52) U.S. Cl. 362/602; 362/606; 362/607

(57) ABSTRACT

A backlight assembly includes a plurality of light sources generating light, a light guide plate and a prism sheet. The light sources include first light sources and second light sources having a different emitting angle from the first light sources. The light guide plate includes an incident surface to which the light is incident, an exiting surface extended from the incident surface, opposing to the incident surface and emitting the incident light and an opposing surface extended from the exiting surface. The opposing surface meets the exiting surface at a substantially straight line. The prism sheet converts the emitted light from the light guide plate.

This application claims priority to Korean Patent Application No. 2011-0009247, filed on Jan. 31, 2011, and all the benefits accruing therefrom under 35 U.S.C. §119, the contents of which are herein incorporated by reference in its entirety.

### BACKGROUND OF THE INVENTION

1. Field of the Invention

Exemplary embodiments of the invention relate to a backlight assembly and a display apparatus having the backlight assembly. More particularly, exemplary embodiments of the invention relate to a backlight assembly for a flat display apparatus and a display apparatus having the backlight assembly.

2. Description of the Related Art

Generally, a display apparatus includes a display panel displaying an image and a backlight assembly providing light to the display panel.

The backlight assembly applies various kinds of light sources. Recently, a light emitting diode (“LED”) is usually applied to small electronic devices.

The backlight assembly is classified as an edge-illumination type and a direct-illumination type according to a position of light sources. In the backlight assembly of the edge-illumination type, a light guide plate for guiding light is disposed adjacent to light sources. In particular, the light guide plate guides a light from the light emitting diode and planarly emits the light. Since an emitting angle of the light emitted from the backlight assembly is generally constant, user's demands for using display devices in various conditions are hard to satisfy. A narrow view angle is required when the display device is personally used, and a wide view angle is required when many people use the display device together. However, the view angle is usually not easy to change.

Moreover, in order to form various types of view angle, a light surface opposing an incident light surface of a light guide plate is formed as a spherical mirror shape, and the incident light is changed to parallel light. Thus, a view angle distribution may be adjusted actively. However, since the spherical mirror shape of the opposed light surface is disposed greatly away from an effective display area of the display panel, the size of the display apparatus is increased and the depth of the bezel is increased.

### BRIEF SUMMARY OF THE INVENTION

Exemplary embodiments of the invention provide a backlight assembly that adjusts angle distribution of emitted light actively and reduces the overall size thereof.

Exemplary embodiments of the invention also provide a display apparatus having the above-mentioned backlight assembly.

According to an exemplary embodiment of the invention, a backlight assembly includes a plurality of light sources generating light, a light guide plate and a prism sheet.

The light sources include first light sources and second light sources having a different emitting angle from the first light sources. The light guide plate includes an incident surface to which the light is incident, an exiting surface extended from the incident surface, opposing to the incident surface and emitting the incident light and an opposing surface extended from the exiting surface. The opposing surface meets the exiting surface at a substantially straight line. The prism sheet converts the emitted light from the light guide plate.

In an exemplary embodiment, the opposing surface includes a zigzag pattern and has greater height than the incident surface.

In an exemplary embodiment, the prism sheet converts the emitted light from the light guide plate so that a progressing direction of the emitted light is substantially perpendicular to the exiting surface.

In an exemplary embodiment, the incident surface may include a light adjusting pattern corresponding to a portion of the light sources.

In an exemplary embodiment, the light adjusting pattern may include a trapezoid pillar shape.

In an exemplary embodiment, the light adjusting pattern may include a spherical shape.

In an exemplary embodiment, the backlight assembly may further include a lens array between the incident surface and the light sources, and including a light adjusting pattern corresponding to a portion of the light sources.

In an exemplary embodiment, the light adjusting pattern may include a convex lens shape.

In an exemplary embodiment, the light sources may include a plurality of light source groups, and each of the light source groups may include at least one of the first light sources, and at least one of the second light sources which are adjacent to the first light sources.

In an exemplary embodiment, the light sources may include a plurality of light source groups, and each of the light source groups may include at least three of the light sources adjacent to each other and having different emitting angle distributions from each other.

In an exemplary embodiment, a reflective layer is on the opposing surface.

In an exemplary embodiment, the zigzag pattern of the opposing surface is on a plane substantially perpendicular to the incident surface and the exiting surface, and a protrusion part of the zigzag pattern may be arranged substantially parallel to the line where the exiting surface and the opposing surface meet.

In an exemplary embodiment, the opposing surface may be substantially parallel to the incident surface.

In an exemplary embodiment, the opposing surface may include a circular arc shape at a plane substantially perpendicular to the incident surface and the exiting surface.

In an exemplary embodiment, the light guide plate further includes a lower surface opposing the exiting surface. A center of the circular arc of the opposing surface may be substantially the same as a point where an extension line of the exiting surface and an extension line of the lower surface meet at a plane substantially perpendicular to the incident surface and the exiting surface.

In an exemplary embodiment, the prism sheet may include a prism pattern at one surface of the prism sheet.

In an exemplary embodiment, the backlight assembly may further include a reflective plate under the light guide plate, the prism sheet may be on the exiting surface, and the prism pattern of the prism sheet faces the exiting surface.

In an exemplary embodiment, the backlight assembly may further include a diffusion sheet on the prism sheet and diffusing the light emitted from the prism sheet.

In an exemplary embodiment, the prism sheet may be under the light guide plate, and a reflective layer may be on the prism pattern of the prism sheet.

In an exemplary embodiment, the prism sheet is under the light guide plate, and a surface of the prism sheet not including the prism pattern may face the light guide plate.

In an exemplary embodiment, the prism sheet may be under the light guide plate, and a surface of the prism sheet including the prism pattern may face the light guide plate.

In an exemplary embodiment, the prism sheet may be adhered to the light guide plate with a transparent adhesive material, and a refractive index of the transparent adhesive material may be smaller than a refractive index of the light guide plate.

In an exemplary embodiment, the backlight assembly may further include a diffusion sheet on the light guide plate and diffusing the light emitted from the exiting surface of the light guide plate.

According to another exemplary embodiment of the invention, a display apparatus includes a plurality of light sources generating light, a light guide plate, a backlight assembly and display panel. The light sources include first light sources and second light sources having a different emitting angle from the first light sources. The light guide plate includes an incident surface to which the light is incident, an exiting surface extended from the incident surface and emitting the incident light, and an opposing surface extended from the exiting surface. The opposing surface meets the exiting surface at a substantially straight line. The backlight assembly includes a prism sheet converting the emitted light from the light guide plate. The display panel is on the backlight assembly and displays an image by using the light provided from the backlight assembly.

In an exemplary embodiment, the opposing surface includes a zigzag pattern and has greater height than the incident surface.

In an exemplary embodiment, the prism sheet converts the emitted light from the light guide plate so that a progressing direction of the emitted light is substantially perpendicular to the exiting surface.

In an exemplary embodiment, the incident surface may include a light adjusting pattern corresponding to a portion of the light sources.

In an exemplary embodiment, the display apparatus may further include a lens array between the incident surface and the light sources, and including a light adjusting pattern corresponding to a portion of the light sources.

In an exemplary embodiment, the light sources may include first light sources, and second light sources having different emitting angles from the first light sources.

In an exemplary embodiment, the display apparatus may further include a light source driving part including a first sub light source driving part driving the first light sources, and a second sub light source driving part driving the second light sources.

In an exemplary embodiment, the backlight assembly may further include a reflective plate under the light guide plate, and the prism sheet may be on the light guide plate.

In an exemplary embodiment, the prism sheet may be under the light guide plate, and a reflective layer may be on the prism pattern of the prism sheet.

In an exemplary embodiment, the prism sheet may be adhered to the light guide plate by a transparent adhesive material, and a refractive index of the transparent adhesive material may be smaller than a refractive index of the light guide plate.

According to exemplary embodiments of a backlight assembly, and a display apparatus having the backlight assembly, a light guide plate has a greater height at an opposing surface than an incident surface, the opposing surface has a zigzag pattern, and the backlight assembly has first light sources, and second light sources having different emitting angle distributions from the first light sources, thereby providing adjustment of an emitting angle distribution of the backlight assembly.

Moreover, the light guide plate has an overall rectangular shape, thereby reducing a size of a frame receiving the display apparatus and simplifying a manufacturing process.

Moreover, a light adjusting pattern is on the incident surface of the light guide plate, thereby providing adjustment of the emitting angle distribution of the backlight assembly.

### BRIEF DESCRIPTION OF THE DRAWINGS

The above and other features and advantages of the invention will become more apparent by describing in detailed exemplary embodiments thereof with reference to the accompanying drawings, in which:

FIG. 1 is an exploded perspective view illustrating an exemplary embodiment of a display apparatus according to the invention;

FIG. 2 is a side view illustrating the light guide plate in FIG. 1;

FIG. 3 is a cross-sectional view taken along line I-I′ in FIG. 1;

FIGS. 4A and 4B are plan views showing directions of an emitting light of first and second light sources of the backlight assembly in FIG. 1;

FIGS. 5A and 5B are graphs representing emitting angle distributions of the emitted light of the first and second light sources of the backlight assembly in FIG. 1;

FIG. 6 is an exploded perspective view illustrating another exemplary embodiment of a display apparatus according to the invention;

FIG. 7 is a cross-sectional view taken along line II-IF in FIG. 6;

FIG. 8 is an exploded perspective view illustrating still another exemplary embodiment of a display apparatus according the invention;

FIG. 9 is a cross-sectional view taken along line III-III′ in FIG. 8;

FIG. 10 is an exploded perspective view illustrating still another exemplary embodiment of a display apparatus according to the invention;

FIG. 11 is a plan view illustrating an exemplary embodiment of a light guide plate of the backlight assembly in FIG. 10;

FIG. 12 is a plan view illustrating still another exemplary embodiment of a light guide plate of the backlight assembly in FIG. 10;

FIG. 13 is an exploded perspective view illustrating still another exemplary embodiment of a display apparatus according to the invention; and

FIG. 14 is a plan view illustrating an exemplary embodiment of a light guide plate of the backlight assembly in FIG. 13.

### DETAILED DESCRIPTION OF THE INVENTION

The foregoing is illustrative of the invention and is not to be construed as limiting thereof. Although a few exemplary embodiments of the invention have been described, those skilled in the art will readily appreciate that many modifications are possible in the exemplary embodiments without materially departing from the novel teachings and advantages of the invention. Accordingly, all such modifications are intended to be included within the scope of the invention as defined in the claims.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. As used herein, “connected” includes physically and/or electrically connected. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “under” relative to other elements or features would then be oriented “above” relative to the other elements or features. Thus, the exemplary term “under” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the invention will be explained in detail with reference to the accompanying drawings.

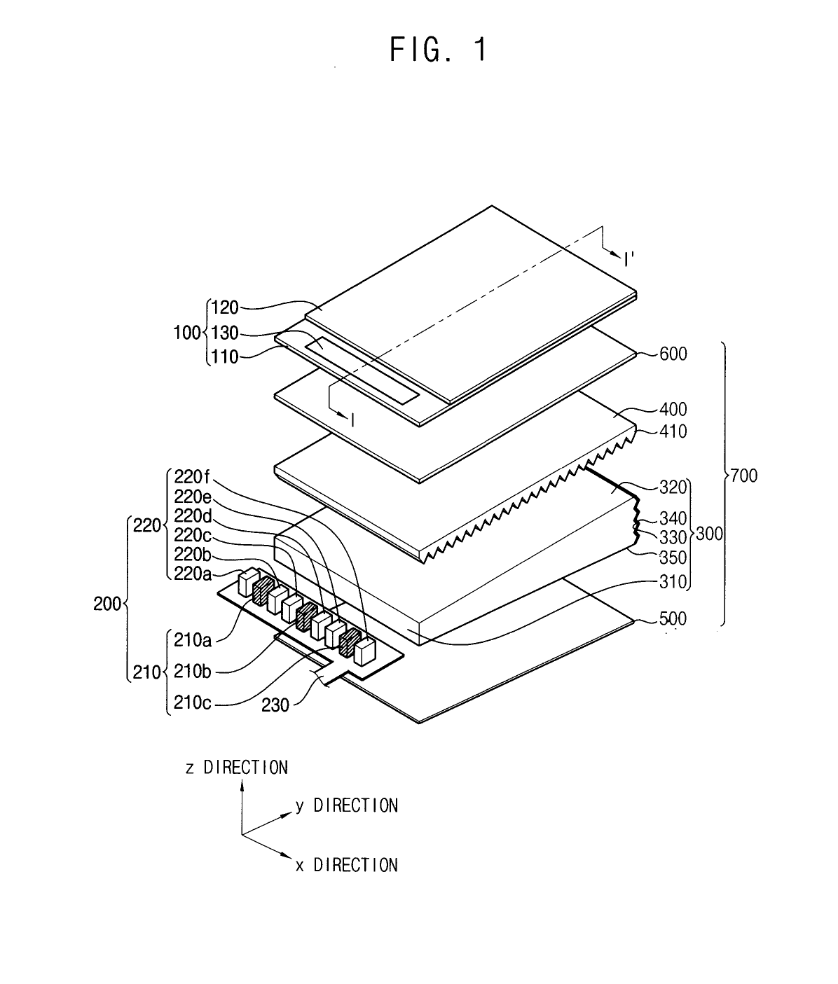

FIG. 1 is an exploded perspective view illustrating an exemplary embodiment of a display apparatus according to the invention.

Referring to FIG. 1, a display apparatus according to the illustrated exemplary embodiment includes a display panel 100 and a backlight assembly 700. The backlight assembly 700 includes light sources 200, a light guide plate 300 and a prism sheet 400.

The display panel 100 displays an image according to driving signals and data signals. The display panel 100 is disposed on and overlapping the backlight assembly 700, and displays an image by using light provided from the backlight assembly 700. The display panel 100 includes an array substrate 110, an opposing substrate 120 facing the array substrate, and a liquid crystal layer disposed between the two substrates 110 and 120. The display apparatus may include a driving chip (not shown) driving the display panel 100 of the display apparatus at a part of the array substrate 110, or a driving pad part 130 connected to an external driving circuit (not shown).

The light sources 200 may include a plurality of light emitting diodes (“LEDs”), which generates light by external driving power with characteristics of a semiconductor. The LED is a point light source having directivity. The LED emits light spreading out from one point. The backlight assembly 700 may include a light source driving film 230, which is electrically connected at a side of the LEDs and applies a driving electrical power. The light sources 200 are disposed adjacent to the light guide plate 300. In particular, the LEDs 200 are disposed adjacent to an incident surface 310 of the light guide plate 300 and emit light toward the incident surface 310.

The light sources 200 include first light sources 210 and second light sources 220 having different emitting angle distribution from each other. In one exemplary embodiment, for example, the second light sources 220 have a wider emitting angle distribution than the first light sources 210. The first light sources 210 and the second light sources 220 are disposed at constant intervals, and one of the second light sources 220 is disposed at opposing sides of one of the first light sources 210. Thus, one light source group is formed with two of the second light sources 220 directly adjacent to one of the first light sources 110.

In particular, the second light sources 220a and 220b are respectively disposed at constant intervals at opposing sides of the one first light source 210a, which is disposed at a farthest point in an x-direction. A first light source group includes the first light source 210a, and the second light sources 220a and 220b. The second light sources 220c and 220d are respectively disposed at opposing sides of the one first light source 210b. A second light source group includes the first light source 210b, and the second light sources 220c and 220d. The second light source group is directly adjacent to a side of the first light source group in the x-direction and with the same pattern as the first light source group. In substantially the same way, a third light source group including the one first light source 210c, and the second light sources 220e and 220 is directly adjacent to a side of the second light source group in the x-direction.

The display apparatus may further include a light source driving part (not shown) driving the light sources 200. The light source driving part controls the light source groups.

In particular, the light source driving part may include a first sub light source driving part (not shown) driving only the first light sources 210 of the light source groups, and a second sub light source driving part (not shown) driving only the second light sources 220 of the light source groups.

The first light sources 210 and the second light sources 220 are disposed in a line and parallel to the x-direction in the illustrated exemplary embodiment. Alternatively, the first light sources 210 and the second light sources 220 may be disposed in other directions and/or arranged in various patterns. In one exemplary embodiment, for example, the first light sources 210 and the second light sources 220 may be combined with various numbers in one of the light source groups, and the numbers of each of the light sources may be modified as necessary.

The light sources 200 include the first light sources 210, and the second light sources 220 having different emitting angle distribution from the first light sources 210 in the illustrated exemplary embodiment. Alternatively, the light sources may include first light sources, second light sources and third light sources which have different emitting angle distributions from each other. In the alternative embodiment, one light source group may include a first light source, a second light source and a third light source which are disposed adjacent to each other.

The number of the light source groups may be modified accordingly to a size of the display apparatus or necessary brightness.

The light guide plate 300 converts point light source or line light source into plane light source distribution. The light guide plate 300 includes the incident surface 310, an exiting surface 320 and an opposing surface 330. The incident surface 310 is at a side of the light guide plate 300 and receives the incident light. The light sources 200 are disposed adjacent to the incident surface 310. The exiting surface 320 is extended from an upper side of the incident surface 310 and the incident light is emitted from the exiting surface 320. The opposing surface 330 is extended from the exiting surface 320 and is opposed to the incident surface 310. The light guide plate 300 has a wedge shape in a cross-sectional view, which is gradually increased in thickness from the incident surface 310 to the opposing surface 330.

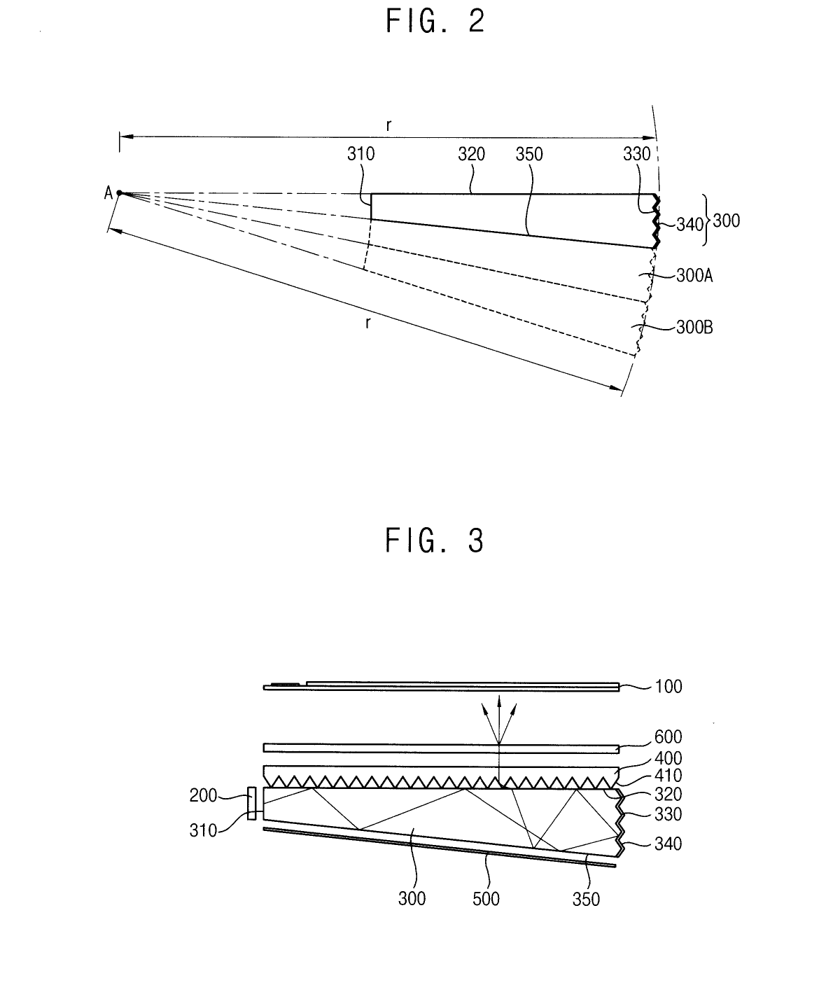

A meeting line where the exiting surface 320 and the opposing surface 330 meet is a substantially straight line. The light guide plate 300 is a substantially rectangular shape in a plan view. The opposing surface 330 has a zigzag pattern at a cross-sectional plane of the light guide plate 300 crossing the light guide plate in a y-z plane. In particular, the zigzag pattern is extended from the meeting line where the exiting surface 320 and the opposing surface 330 meet. Protrusion portions of the zigzag pattern are longitudinally extended substantially parallel to the meeting line where the exiting surface 320 and the opposing surface 330 meet. A direction of the zigzag pattern of the opposing surface 330 will be described in detail with reference to FIG. 2 later.

A reflective layer 340 for reflecting light is at the opposing surface 330. The reflective layer 340 reflects the light, which is incident to the incident surface 310 and passes through the light guide plate 300 and arrives at the opposing surface 330. The reflective layer 340 may be formed by various methods. In one exemplary embodiment, for example, the reflective layer 340 may be formed by depositing metals at the opposing surface 330. The metals may include silver, such as included in a mirror, aluminum, chrome, nickel and so on.

The prism sheet 400 includes a plurality of prism patterns 410, which is longitudinally extended in the x-direction at a surface of the prism sheet 400. In the illustrated exemplary embodiment, the prism sheet 400 is disposed on and overlapping the exiting surface 320 of the light guide plate 300, so that the prism pattern 410 may face the exiting surface 320. The prism sheet 400 converts the light emitted from the light guide plate 300 to a direction substantially perpendicular to the exiting surface 320 through the prism pattern 410. In particular, the light emitted from the exiting surface 320 of the light guide plate 300 is usually emitted at a relatively small angle with respect to the exiting surface 320. Thus, the light emitted at a small angle with respect to the exiting surface 320 is totally reflected at the prism pattern 410 and proceeds in the direction substantially perpendicular to the exiting surface 320.

The backlight assembly 700 may further include a reflective plate 500. The reflective plate 500 is disposed under the light guide plate 300 and reflects the light emitted from the light guide plate 300. In particular, a part of the light, which is incident to the light guide plate 300, does not emit into the exiting surface 320 of the light guide plate 300 and is emitted through a bottom surface 350 of the light guide plate 300, which is opposed to the exiting surface 320. Thus, the reflective plate 500 re-reflects the light emitted through the bottom surface 350 and guides the light into the exiting surface 320 of the light guide plate 300.

The backlight assembly 700 may further include a diffusion sheet 600. The diffusion sheet 600 may improve brightness angle distribution and brightness uniformity by diffusing the light emitted from the prism sheet 400. The diffusion sheet 600 may be included selectively since remaining elements of the backlight assembly 700 alone may provide a uniform brightness characteristic in the illustrated exemplary embodiment.

FIG. 2 is a side view illustrating the light guide plate in FIG. 1.

Referring to FIGS. 1 and 2, the light guide plate 300 has a wedge shape in the cross-sectional view, which is gradually increased in thickness from the incident surface 310 to the opposing surface 330. The meeting line where the exiting surface 320 and the opposing surface 330 meet has a substantially straight shape. The opposing surface 330 is a circular arc shape extending from the exiting surface 320 to the bottom surface 350, and includes a zigzag pattern at a cross-sectional plane of the light guide plate 300 crossing the light guide plate 300 in a y-z plane. The zigzag pattern is arranged along the circular arc of the opposing surface 330 at the cross-sectional plane of the light guide plate 300 in the y-z plane.

In particular, a collective pile of the light guide plate 300, and imaginary light guide plates 300A and 300B (shown in dotted lines) forms a part of a cylinder with a radius of r by repeating the shape of the light guide plate 300 including the thickness gradually increasing from the incident surface 310 to the opposing surface 330. The center of the circular arc of the opposing surface 330 of the light guide plate 300 is substantially the same as a center point A of the cylinder formed by repeating the shape of the light guide plate 300. The center point A is a meeting point of an extension line of the exiting surface 320 of the light guide plate 300 and an extension line of the bottom surface 350 of each of the light guide plate 300 shapes. The zigzag pattern is extended along the opposing surface 330 of the light guide plate 300. The zigzag pattern is arranged along the circular arc of the opposing surface 300, and thus the light arriving at the opposing surface 330 may be uniformly reflected, and the brightness of the light emitted into the exiting surface 320 may be uniformly distributed.

In the illustrated exemplary embodiment, the opposing surface 330 is extended along the circular arc described above. Alternatively, the opposing surface 330 may be another shape in the cross-sectional view. In one exemplary embodiment, for example, the opposing surface 330 may be extended along a substantially straight line at the cross-sectional plane of the light guide plate 300 crossing the light guide plate 300 in the y-z plane. The opposing surface 330 may be substantially parallel to the incident surface 310.

FIG. 3 is a cross-sectional view taken along line I-I′ in FIG. 1.

Referring to FIGS. 1 and 3, the light emitted from the light sources 200 is incident into the incident surface 310 of the light guide plate 300. The incident light is totally reflected at the exiting surface 320 and the bottom surface 350 in the light guide plate 300. Since the thickness of the light guide plate 300 is gradually increased, the incident light is not emitted out of the light guide plate 300 until arriving at the opposing surface 330. When the totally reflected light arrives at the opposing surface 330, the light is reflected by the reflective layer 340 at the opposing surface 330. The reflected angle of the reflected light is greater than the incident angle of the incident light because of the zigzag pattern at the opposing surface 330. The light, which is reflected at the opposing surface 330 and proceeds to the incident surface 310 again, could not be totally reflected at the exiting surface 320 and the bottom surface 350 during moving to the incident surface 310 since the thickness of the light guide plate 300 is gradually decreased. The light, which moves from the opposing surface 330 to the incident surface 310, is emitted out of the exiting surface 320 or the bottom surface 350.

The light emitted from the exiting surface 320 of the light guide plate 300 is converted by the prism pattern 410 of the prism sheet 400, which is disposed on the exiting surface 320. In particular, the light, which is emitted at relatively small angle with respect to the exiting surface 320, is totally reflected at the prism pattern 410 of the prism sheet 400 at relatively great angle with respect to the exiting surface 320. Thus, the light emitted from the exiting surface 320 is converted in the direction substantially perpendicular to the exiting surface 320.

The light emitted from the bottom surface 350 of the light guide plate 300 is reflected by the reflective plate 500, which is disposed under the light guide plate 300. The reflected light has substantially the same reflected angle with the incident angle at the reflective plate 500 and the reflected light is emitted from the exiting surface 320. The light emitted from the exiting surface 320 is converted through the prism sheet 400, so that the light emitted from the prism sheet 400 has a relatively great angle with respect to the exiting surface 320.

The light guide plate 300 according to the illustrated exemplary embodiment may increase the reflected angle of the incident light arriving at the opposing surface 330 by the zigzag pattern at the opposing surface 330. Moreover, since the light guide plate 300 has a thickness which is increased gradually from the incident surface 310 to the opposing surface 330, the light reflected at the opposing surface 330 may be emitted effectively and uniformly into the exiting surface 320.

The emitting angle distribution in the y-direction of the emitted light from the backlight assembly 700 may be changed according to the angle of the wedge shape of the light guide plate 300 and the diffusion sheet 600. However, the emitting angle distribution in the z-direction of the emitted light from the backlight assembly 700 may be substantially constant. The emitting angle distribution in the x-direction of the light emitted from the backlight assembly 700 is changed accordingly to the emitting angle distribution of the light sources 200. When the emitting angle distribution of the light sources 200 in the x-direction is narrow, the emitting angle distribution of the backlight assembly 700 is also narrow. When the emitting angle distribution of the light sources 200 in the x-direction is wide, the emitting angle distribution of the backlight assembly 700 is also wide.

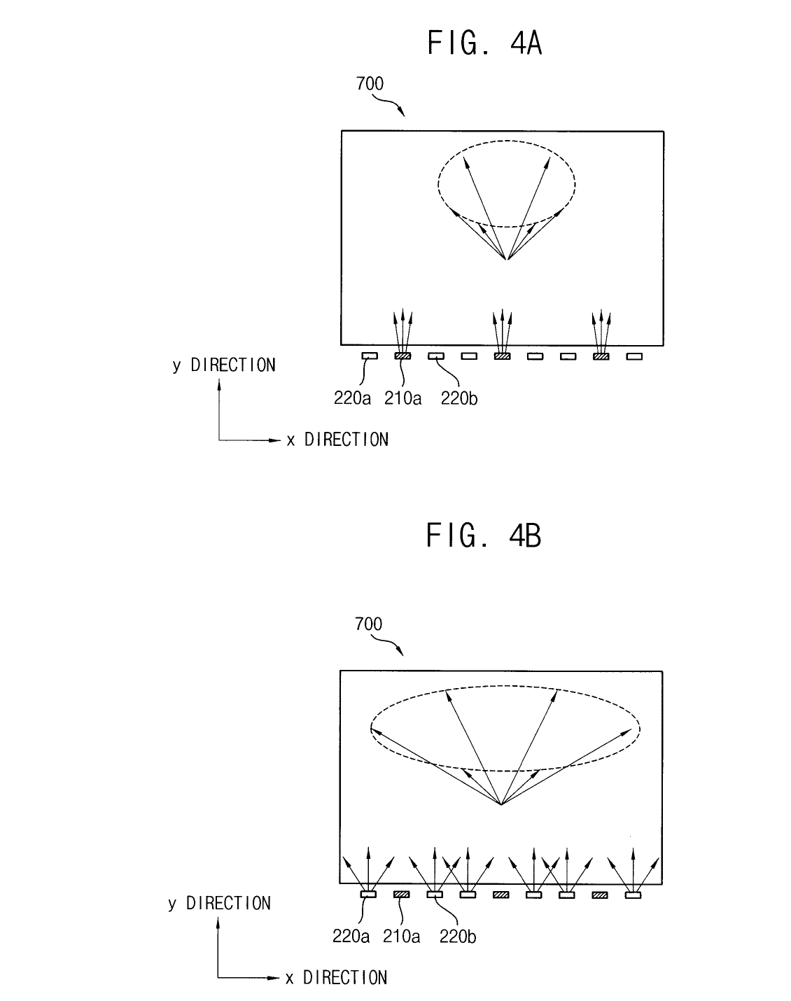

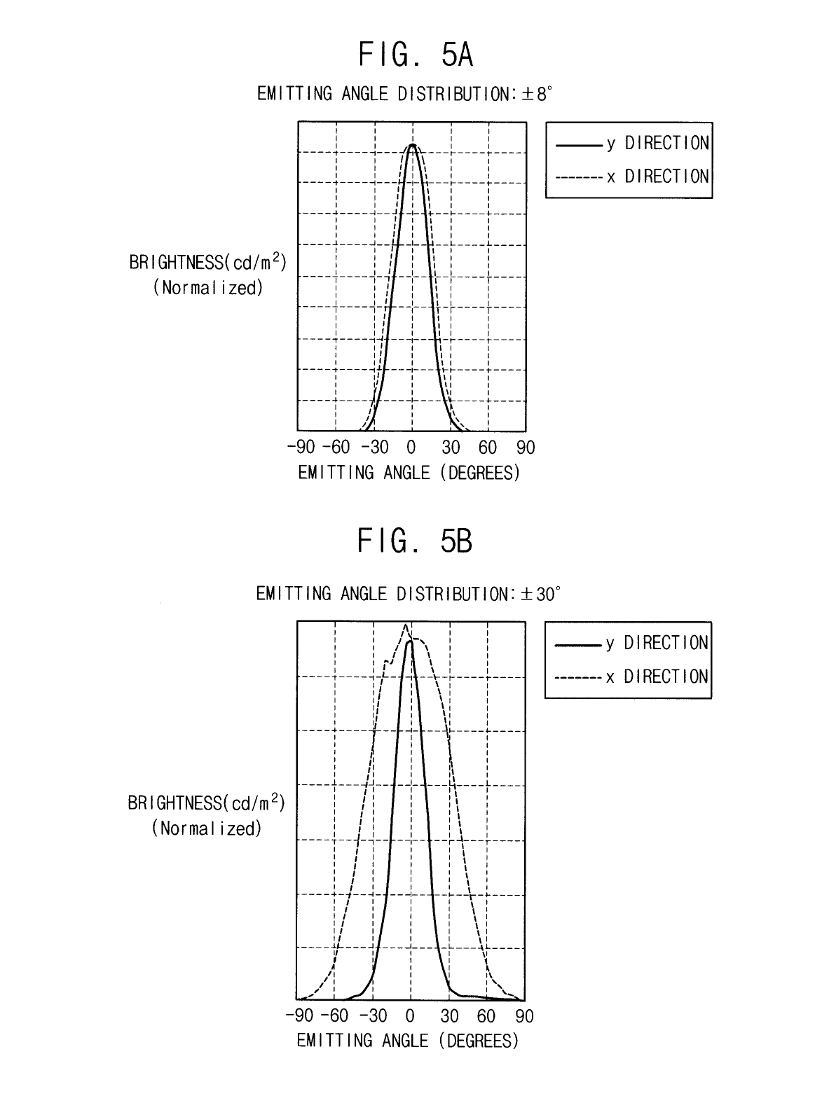

FIGS. 4A and 4B are plan views showing directions of an emitting light of first and second light sources 210 and 220 of the backlight assembly in FIG. 1.

Referring to FIGS. 4A and 4B, the backlight assembly 700 includes the first light sources 210 and the second light sources 220. The second light sources 220 have different light emitting distribution from the first light sources 210. The first light source 210a has a narrower emitting angle distribution in the x-direction than the second light sources 220a and 220b. The second light sources 220a and 220b have a wider emitting angle distribution in the x-direction than the first light source 210a.

When only the first light sources 210 are driven in the backlight assembly 700, the light emitted from the diffusion sheet 600 has a narrow emitting angle distribution in the x-direction. Thus, when only the light having the narrow emitting angle distribution in the x-direction is used, the emitting light from the backlight assembly 700 may be controlled to have a narrow emitting angle distribution in the x-direction.

When only the second light sources 220 are driven in the backlight assembly 700, the light emitted from the diffusion sheet 600 has a wide emitting angle distribution in the x-direction. Thus, when only the light having the wide emitting angle distribution in the x-direction is used, the emitting light from the backlight assembly 700 may be controlled to have a wide emitting angle distribution in the x-direction.

Consequentially, when driving only the light sources 200 having the narrow emitting angle distribution in the x-direction in the backlight assembly 700, the angle distribution of the emitting light from the backlight assembly 700 may be controlled to be narrow. Thus, the user may see the image with the narrow range, and thus one person or a few people are permitted to see the image displayed by the liquid crystal display in a private mode.

Alternatively, when driving only the light sources 200 having the wide emitting angle distribution in the x-direction in the backlight assembly 700, the angle distribution of the emitting light from the backlight assembly 700 may be controlled to be wide. Thus, the user may see the image with the wide range, and thus many people are permitted to see the image displayed by the liquid crystal display in a public mode.

Thus, the display apparatus according to the illustrated exemplary embodiment may display in the two driving modes. In the private mode, one person or a few people could see the image with the narrow emitting angle distribution of the backlight assembly 700. In the public mode, many people could see the image with the wide emitting angle distribution of the backlight assembly 700.

Moreover, the display apparatus according the illustrated exemplary embodiment may have uniform brightness distribution in the x-direction. The incident light to the incident surface 310 of the light guide plate 300 is continuously totally reflected within the light guide plate 300 and until emitted out of the light guide plate 300. Thus, the brightness distribution in the x-direction in the display apparatus of the illustrated exemplary embodiment may be uniformized. Thus, the high uniformity of the brightness could be achieved even with the narrow emitting angle distribution such as used for the private mode.

FIGS. 5A and 5B are graphs representing emitting angle distributions of the emitted light of the first and second light sources 210 and 220 of the backlight assembly 700 in FIG. 1.

Referring to FIGS. 5A and 5B, the simulation result of the emitting angle distribution of the backlight assembly 700 according to the emitting angle distribution of the light sources 200, is presented. In the present simulation, twenty light sources 200 are disposed at the incident surface 310 of the light guide plate 300 at constant intervals, the refractive index of the light guide plate 300 is about 1.495, and the planar size of the light guide plate 300 is about 15.6 inches. The prism sheet 400 is disposed on the light guide plate 300, and the diffusion sheet 600 is disposed on the prism sheet 400. The prism sheet 400 in the present simulation emits the light diffused as about 24 Gaussian angle distribution of Full-Width Half-Maximum (“FWHM”). The angle distribution of the light emitted from the upper portion of the diffusion sheet 600 is simulated in the condition that the light from the light sources 200 is incident into the light guide plate 300. FIGS. 5A and 5B are graphs showing the brightness angle distribution of the light emitting at the center of the backlight assembly 700 having the planar area of about 15.6 inches.

Referring to FIG. 5A, when the emitting angle distribution in the x-direction of the light source is within about ±8 degrees with respect to the point where the brightness is one-tenth of the maximum brightness, the emitting angle distribution in the x-direction of the backlight assembly 700 is within about ±28 degrees with respect to the point where the brightness is one-tenth of the maximum brightness measured at the backlight assembly 700.

Referring to FIG. 5B, when the emitting angle distribution in the x-direction of the light source is within about ±30 degrees with respect to the point where the brightness is one-tenth of the maximum brightness, the emitting angle distribution in the x-direction of the backlight assembly 700 is within about ±60 degrees with respect to the point where the brightness is one-tenth of the maximum brightness measured at the backlight assembly 700. Thus, by driving the light sources having different emitting angle distributions separately, the emitting angle distribution of the backlight assembly 700 may be controlled actively. The following <Table 1> represents the results in the present simulation.

TABLE 1

| | Private Mode | Public Mode |
|---|---|---|
| Emitting angle distribution of | x-direction: ±8 | x-direction: ±30 |
| the light source | degrees | degrees |
| (with respect to the point | y-direction: ±27 | y-direction: ±30 |
| where the brightness is a | degrees | degrees |
| tenth of the maximum | | |
| brightness) | | |
| Emitting illumination | ~75% | ~80% |
| uniformity of backlight | | |
| assembly | | |
| Emitting angle distribution of | x-direction: ±28 | x-direction: ±60 |
| backlight assembly | degrees | degrees |
| (with respect to the point | y-direction: ±24 | y-direction: ±24 |
| where the brightness is a | degrees | degrees |
| tenth of the maximum | | |
| brightness on the diffusive | | |
| sheet) | | |

The display apparatus of the illustrated exemplary embodiment includes the first light sources 210, and the second light sources 220 having different emitting angle distributions from the first light sources, and thus the emitting angle distribution of the backlight assembly 700 may be controlled actively. Moreover, the light guide plate 300 of the backlight assembly 700 of the illustrated exemplary embodiment has a substantially rectangular planar shape, and thus the size of a frame receiving the display apparatus may be effectively reduced. Moreover, the manufacturing process of the light guide plate 300 may be simplified.

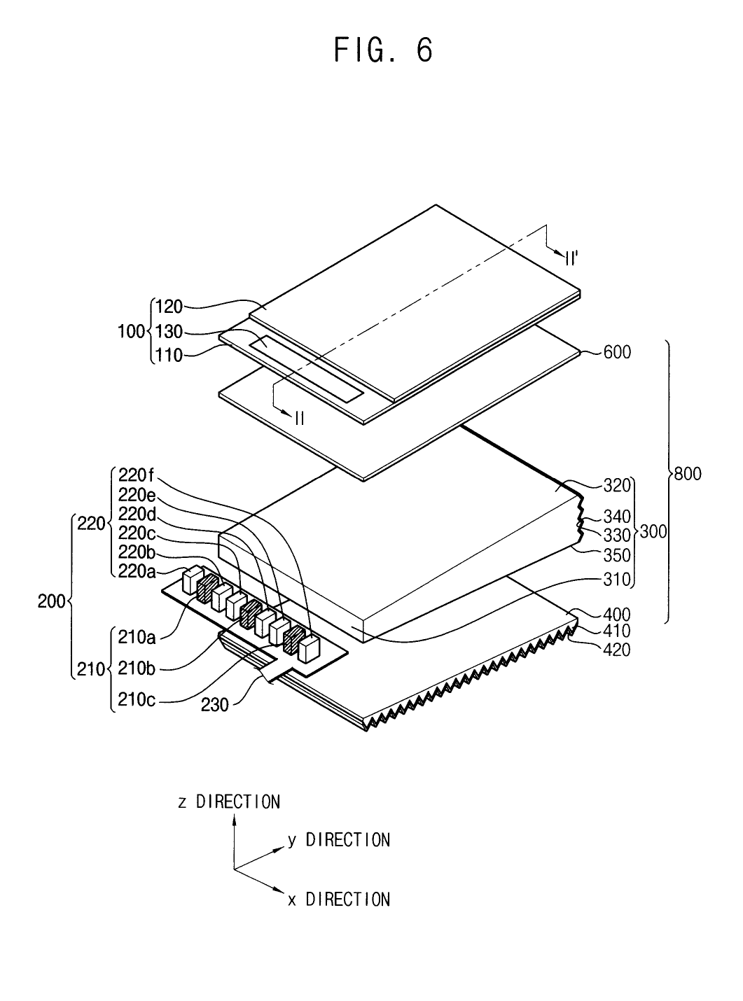

FIG. 6 is an exploded perspective view illustrating another exemplary embodiment of a display apparatus according to the invention.

Referring to FIG. 6, the display apparatus of the illustrated exemplary embodiment includes the display panel 100 and a backlight assembly 800. The backlight assembly 800 includes the light sources 200, the light guide plate 300 and the prism sheet 400. The display apparatus of the illustrated exemplary embodiment is substantially the same as the display apparatus of the exemplary embodiment in FIG. 1, except that the reflective plate 500 is not included, a reflective layer for reflecting the light is at the prism pattern 410 of the prism sheet 400 and the prism sheet 400 is disposed under the light guide plate 300. Thus, the same numerical references will be used and the repeated descriptions will be omitted.

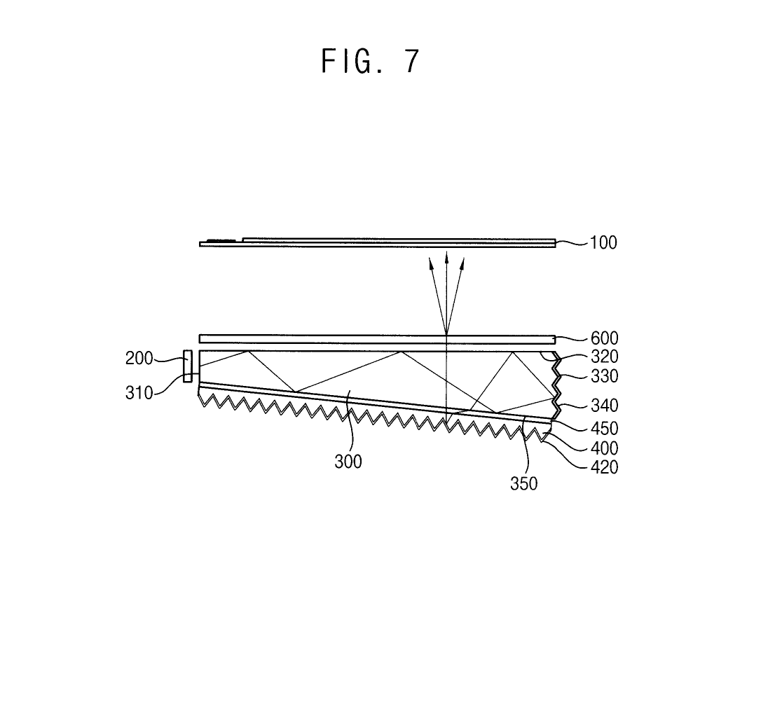

The prism sheet 400 includes the prism pattern 410 longitudinally extended in the x-direction at one surface of the prism sheet 400. The prism sheet 400 is disposed under the light guide plate 300 opposite to a viewing side of display apparatus, so that the surface of the prism sheet 400 not including the prism pattern 410 faces the light guide plate 300. The prism sheet 400 is adhered to a bottom surface of the light guide plate 300, such as by an adhesive material. The adhesive material has a smaller refractive index than the refractive index of the light guide plate 300. In one exemplary embodiment, for example, the refractive index of the adhesive material may be between about 1.32 and 1.40 when the refractive index of the light guide plate 300 is about 1.495. With such a refractive index of the adhesive material, when light is reflected at the opposing surface 330 of the light guide plate 300 and proceeds to the incident surface 310, the light is not reflected to the exiting surface 320 and is reflected to only the bottom surface 350. The proceeding process of the light will be described with reference to FIG. 7 later.

A reflective layer 420 is at the prism pattern 410 of the prism sheet 400. The reflective layer 420 reflects the light, which is emitted to the bottom surface 350 of the light guide plate 300, and arrives at the prism pattern 410 of the prism sheet 400. The reflective layer 420 may be variously shaped. In one exemplary embodiment, for example, the reflective layer 420 may be formed by depositing metals on the surface of the prism pattern 410 of the prism sheet 400. The light arriving at the prism pattern 410 of the prism sheet 400 is reflected at the metal layer and has a reflected angle according to the plane angle of the each prism in the prism pattern 410. The proceeding process of the light in the backlight assembly 800 will be described with reference to FIG. 7 later. The reflective plate may be omitted in the backlight assembly 800 by forming metal layer at the prism pattern of the prism sheet 400.

When the prism sheet 400 is disposed on the light guide plate 300, the exiting surface 320 of the light guide plate 300 may be damaged by the prism pattern 410 of the prism sheet 400. When damage, such as a scratch, is caused at the exiting surface 320, the uniformity of the brightness is not guaranteed. In the illustrated exemplary embodiment, the prism sheet 400 is disposed under the light guide plate 300 with the non-prism pattern 410 side contacting the light guide plate 300. Thus, the damage of the light guide plate 300 by the prism pattern 410 of the prism sheet 400 may be reduced or effectively prevented.

FIG. 7 is a cross-sectional view taken along line II-IF in FIG. 6.

Referring to FIGS. 6 and 7, the light emitted from the light sources 200 is incident into the incident surface 310. The incident light is totally reflected at the exiting surface 320 and the bottom surface 350 and proceeds in the light guide plate 300. Since the thickness of the light guide plate 300 is gradually increased in a direction away from the incident surface 310, the incident light is totally reflected and is not emitted out of the light guide plate 300 during the proceeding. When the light arrives at the opposing surface 330, the light is reflected by the reflective layer 340 on the opposing surface 330. The light is reflected with a larger angle than the incident angle at the reflected layer 340 by the zigzag pattern of the opposing surface 330.

The light proceeding toward the incident surface 310 after begin reflected at the opposing surface 330 is not totally reflected and is emitted out at the exiting surface 320 or the bottom surface 350 since the thickness of light guide plate 300 is gradually decreased in a direction away from the opposing surface 330 and toward the incident surface 310. In particular, an air layer is between the light guide plate 300 and the diffusion sheet, 600, and an adhesive material layer 450 is between the light guide plate 300 and the prism sheet 400. The refractive index of the light guide plate 300 may be about 1.495, the refractive index of the air layer may be about 1.0 and the refractive index of the adhesive material layer 450 may be between about 1.32 to about 1.40. Thus, the total reflection angle is greater at the bottom surface 350 than at the exiting surface 320 of the light guide plate 300, and the proceeding light after being reflected at the opposing surface 330 is emitted only through the bottom surface 350 of the light guide plate 300.

The emitted light from the bottom surface 350 of the light guide plate 300 is refracted by the adhesive material layer 450 at first, is refracted by the prism sheet 400 again, and the light arriving at the surface of the prism sheet 300 is reflected with a different angle according to the surfaces of the prisms. The reflected light proceeds in the light guide plate 300 and is emitted from the exiting surface 320, and is diffused by the diffusion sheet 600.

The emitting angle distribution of the backlight assembly 800 having the first light sources 210 and the second light sources 220 is substantially the same as the emitting angle distribution of the backlight assembly 700 in FIGS. 4A to 5B. Thus, different display modes may be selected by driving only the first light sources 210 or by driving only the second light sources 220. In the private mode, one person or a few people see the image by narrowing the emitting angle distribution of the backlight assembly 800. In the public mode, many people see the image by widening the emitting angle distribution of the backlight assembly 800.

The emitting angle distribution of the backlight assembly 800 may be adjusted actively by including the first light sources 210 and the second light sources 220 having different emitting angle distributions from each other. Moreover, the size of the frame receiving the display apparatus may be effectively reduced by the rectangular planar shaped light guide plate 300 of the backlight assembly 800. Moreover, the size of the display apparatus may be reduced effectively and the damage of the light guide plate 300 may be reduced or effectively prevented by omitting the reflective plate in the backlight assembly 800.

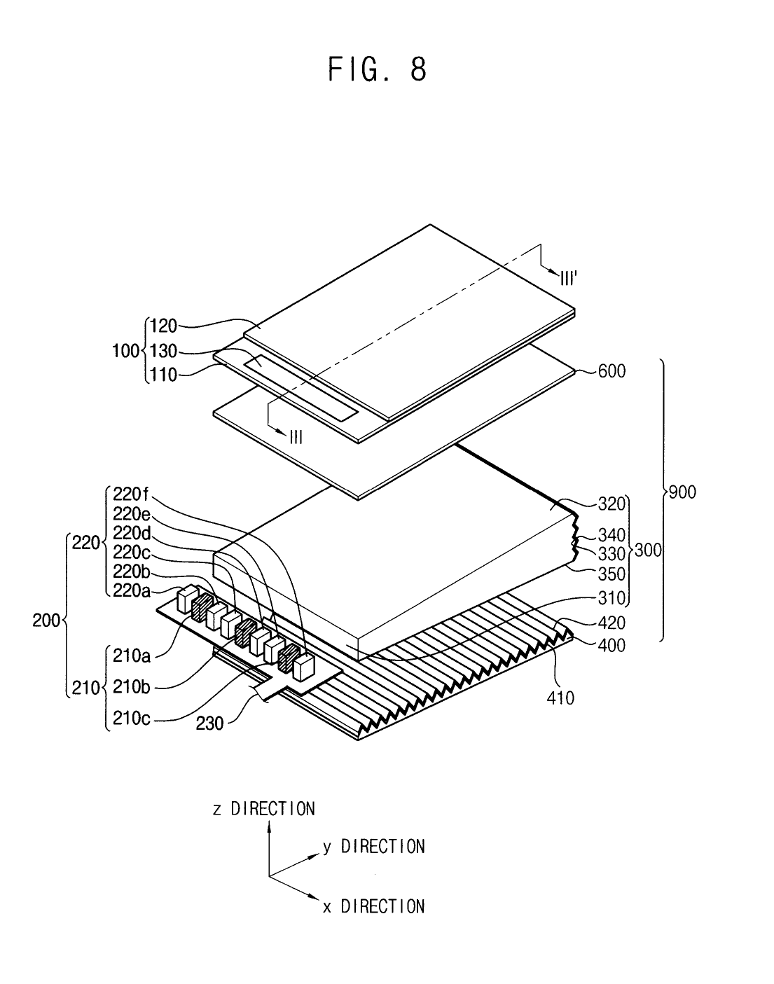

FIG. 8 is an exploded perspective view illustrating still another exemplary embodiment a display apparatus according to the invention.

Referring to FIG. 8, the display apparatus of the illustrated exemplary embodiment includes the display panel 100 and a backlight assembly 900. The backlight assembly 900 includes the light sources 200, the light guide plate 300 and the prism sheet 400. The display apparatus of the illustrated exemplary embodiment is substantially the same as the display apparatus of the exemplary embodiment in FIG. 6, except that the prism pattern 410 of the prism sheet 400 is disposed to face the light guide plate 400. Thus, the same numerical references will be used and the repeated descriptions will be omitted.

The prism sheet 400 includes the prism pattern 410 longitudinally extended in the x-direction at one surface of the prism sheet 400. The prism sheet 400 is disposed under the light guide plate 300, so that the one surface of the prism sheet 400 not including the prism pattern 410 faces the light guide plate 300. The prism sheet 400 is adhered to the bottom surface 350 of the light guide plate 300 by an adhesive material. The adhesive material has a smaller refractive index than the refractive index of the light guide plate 300.

The reflective layer 420 is at the prism pattern 410 of the prism sheet 400 for reflecting the light. The reflective layer 420 reflects the light again, which is emitted from the bottom surface 350 of the light guide plate 300 and arrives at the prism pattern 410 of the prism sheet 400. The reflective plate for reflecting the light may be omitted in the backlight assembly 900 by forming a metallic reflective layer at the prism pattern 410 of the prism sheet 400.

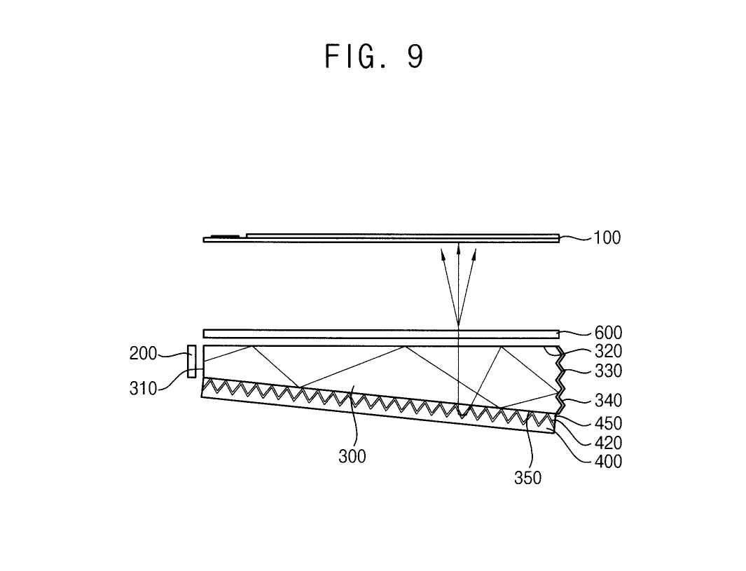

FIG. 9 is a cross-sectional view taken along line III-III′ in FIG. 8. The display apparatus of the illustrated exemplary embodiment is substantially the same as the display apparatus of the exemplary embodiment in FIG. 7, except that the light emitted from the bottom surface 350 of the light guide plate 300 is directly reflected at the prism surface of the prism sheet 400 without passing through the prism sheet 400. Thus, the same numerical references will be used and the repeated descriptions will be omitted.

Referring to FIG. 9, the light emitted from the bottom surface 350 of the light guide plate 300 is refracted by the adhesive material layer 450 at first, and the light arriving at the prism surface of the prism sheet 400 is reflected with different angles according to the surfaces of the prism pattern 410. The reflected light passes through the light guide plate 300 and is emitted through the exiting surface 320 of the light guide plate 300 and is diffused by the diffusion sheet 600.

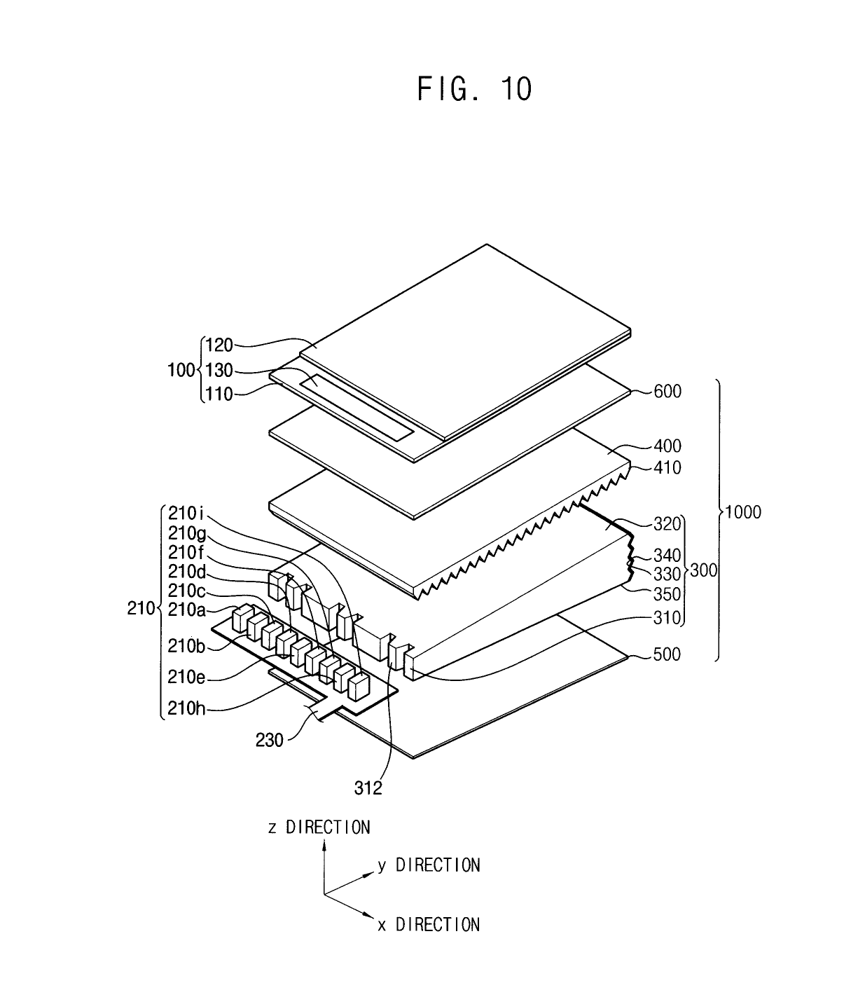

FIG. 10 is an exploded perspective view illustrating still another exemplary embodiment of a display apparatus according to the invention. The display apparatus of the illustrated exemplary embodiment is substantially the same as the display apparatus of the exemplary embodiment in FIG. 1, except for the combination of the light sources 200 and the shape of the incident surface 310 of the light guide plate 300. Thus, the same numerical references will be used and the repeated descriptions will be omitted.

Referring to FIG. 10, a display apparatus of the illustrated exemplary embodiment includes the display panel 100 and a backlight assembly 1000. The backlight assembly 1000 includes the first light sources 210, the light guide plate 300, the prism sheet 400 and the reflective plate 500.

The first light sources 210 include light sources having substantially the same emitting angle distribution. The first light sources 210 are disposed adjacent to the incident surface 310 of the light guide plate at constant intervals, and include first to ninth first light sources 210a to 210i.

The light guide plate 300 converts the incident light generated from a point light source or a line light source into emitted light as planar light source distribution. The light guide plate 300 includes the incident surface 310, the exiting surface 320 and the opposing surface 330. The incident surface 310 is at a side of the light guide plate 300 and the incident light is incident to the incident surface 310. The light sources 200 are disposed adjacent to the incident surface 310.

Light adjusting patterns 312 including a plurality of light adjusting protrusions are on the incident surface 310 of the light guide plate 300 for adjusting emitting angle distribution of the incident light from the light sources 200. The light adjusting pattern 312 will be described in detail with reference to FIG. 11 later.

FIG. 11 is a plan view illustrating an exemplary embodiment of the light guide plate 300 of the backlight assembly 1000 in FIG. 10.

Referring to FIGS. 10 and 11, the light adjusting patterns 312 are on the incident surface 310 of the light guide plate 300 and correspond to the light sources 200. The light guide plate 300 is a single unitary indivisible element which includes the light adjusting patterns 312 continuous with a substantially rectangular planar main portion of the light guide plate 300. As used herein, corresponding may mean aligned in positional placement, or being similar in dimension or shape. The light adjusting patterns 312 protrude from the common light incident surface 310 and include a trapezoid pillar shape in a cross-sectional view. In one exemplary embodiment, for example, one of the light adjusting patterns 312 having the trapezoid pillar shape is at a position aligned with the second first light source 210b in the x-direction. Moreover, one of the light adjusting patterns 312 having the trapezoid pillar shape also is at a position aligned with the fifth first light source 210e in the x-direction. In the same pattern, one of the light adjusting patterns 312 is on the incident surface 310 of the light guide plate 300 and aligned with the eighth first light source 210h in the x-direction. The positions of the light adjusting patterns 312 are not limited in the illustrated exemplary embodiment and may have various other patterns.

The light adjusting patterns 312 adjust an emitting angle distribution of the light, which is incident from the first light sources 210b, 210e and 210h to the incident surface 310 according to the light adjusting patterns 312. In particular, the emitting angle distribution of the light, which is incident from the first light sources 210b, 210e and 210h according to the light adjusting patterns 312, is narrowed by the trapezoid pillar shape. However, the emitting angle distribution of the incident light is sustained absent the light adjusting patterns because the emitting angle distribution is not effected. Thus, the emitting angle distribution could be selectively diversified by the light adjusting patterns at the incident surface 310 of the light guide plate 300, even if the light sources 200 having substantially the same emitting angle distribution are disposed.

As mentioned the above, the emitting angle distribution of a portion of the light, which is incident to the light guide plate 300 is selectively affected by the light adjusting patterns 312 on the light incident surface 310. The emitting angle distribution in the x-direction of the light emitted from the backlight assembly 1000 may be controlled as described in FIG. 1. In particular, when only the first light sources 210b, 210e and 210h corresponding to the light adjusting patterns 312 are turned on, the emitting angle distribution in the x-direction of the light emitted from the backlight assembly 1000 may be controlled to be narrow, and thus the user could see the image in the private mode in the display apparatus.

Alternatively, when only the first light sources 210 which do not correspond with the light adjusting patterns are turned on, the emitting angle distribution in the x-direction of the light emitted from the backlight assembly 1000 may be controlled to be wide, and thus the user could see the image in the public mode in the display apparatus. Thus, two different modes could be applied in the display apparatus of the illustrated exemplary embodiment.

The structure of the backlight assembly 1000 of the illustrated exemplary embodiment is not limited as described. The light adjusting patterns 312 may be applied to the structure in which the prism sheet 400 is disposed under the light guide plate 300 as the backlight assembly 800 and 900 in the exemplary embodiments in FIGS. 6 and 8.

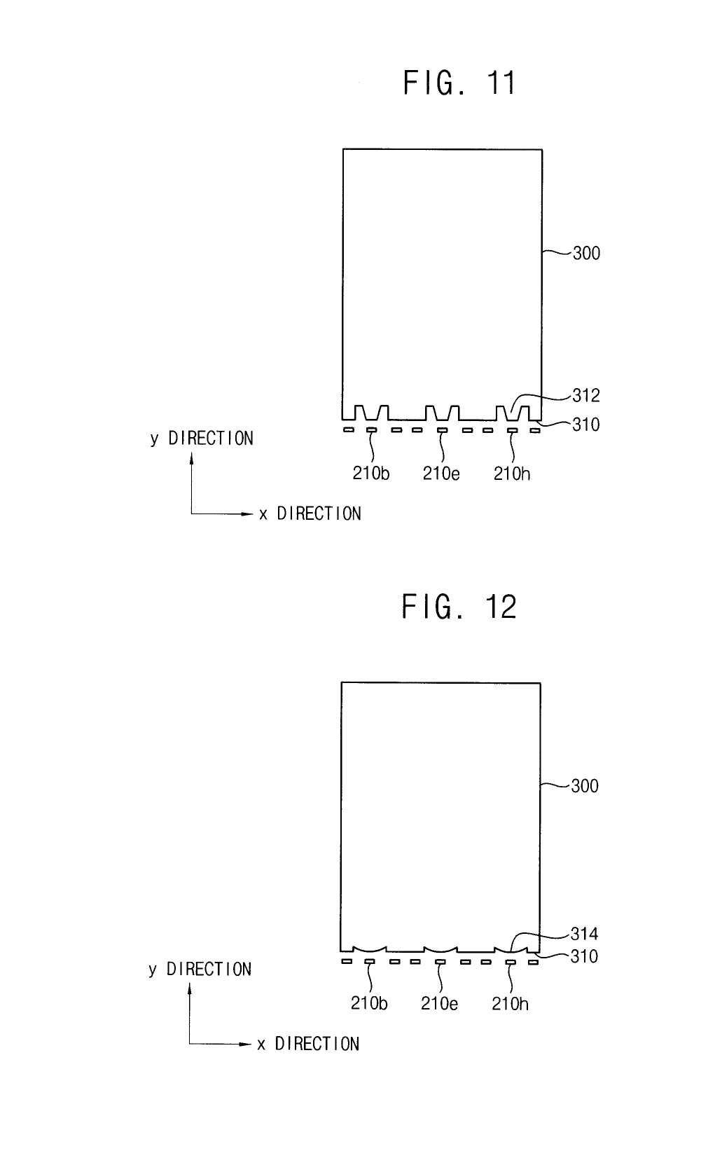

FIG. 12 is a plan view illustrating another exemplary embodiment of the light guide plate 300 of the backlight assembly 1000 according to the invention. The display apparatus of the illustrated exemplary embodiment is substantially the same as the display apparatus of the exemplary embodiment in FIGS. 10 and 11, except that the light adjusting pattern includes a lens shape. Thus, the same numerical references will be used and the repeated descriptions will be omitted.

Referring to FIG. 12, light adjusting patterns 314 having a circular arc shape of a convex lens correspond to a portion of the first light sources 210 at the incident surface 310 of the light guide plate 300. In one exemplary embodiment, for example, one of the light adjusting patterns 314 having the circular arc shape of the convex lens corresponds to the second first light source 210b in the x-direction. Moreover, one of the light adjusting patterns 314 having the circular arc shape of the convex lens also corresponds to the fifth first light source 210e in the x-direction. In the same pattern, the light adjusting patterns 314 are on the incident surface 310 of the light guide plate 300.

The light adjusting patterns 314 adjust emitting angle distribution of the light, which is incident from the first light sources 210b, 210e and 210h to the incident surface 310 according to the light adjusting patterns 314. In particular, the emitting angle distribution of the light, which is incident from the first light sources 210b, 210e and 210h according to the light adjusting patterns 314, is narrowed by the circular arc shape of the convex lens. However, the emitting angle distribution of the incident light is sustained absent the light adjusting patterns 314 because the emitting angle distribution is not effected. Thus, the emitting angle distribution could be diversified by the light adjusting patterns selectively on the incident surface 310 of the light guide plate 300 even if the first light sources 210 have substantially the same emitting angle distribution.

The emitting angle distribution of a portion of the incident light which is incident into the light guide plate 300 may be controlled by the light adjusting patterns 314. Thus, two different modes could be applied in the display apparatus of the illustrated exemplary embodiment.

The shape of the light adjusting patterns 314 of the illustrated exemplary embodiment, which is the circular arc shape of the convex lens, is not limited as described the above. The light adjusting patterns 314 may be a rectangular pillar shape protruding from the light incident surface 310, and may be modified as long as the light adjusting patterns 314 could adjust the emitting angle distribution.

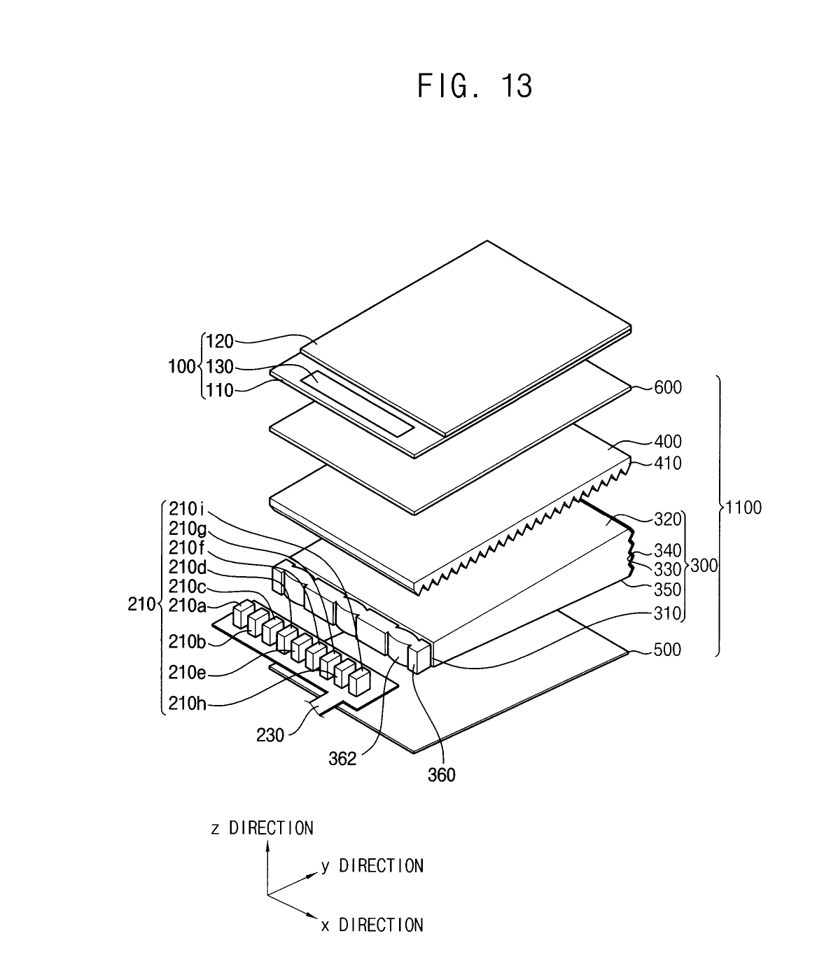

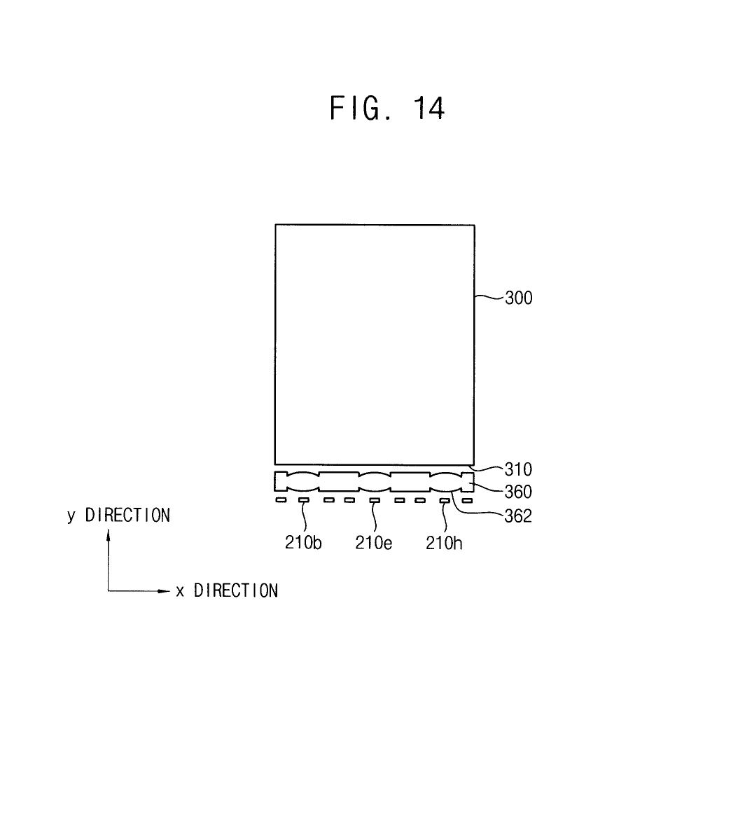

FIG. 13 is an exploded perspective view illustrating still another exemplary embodiment of a display apparatus according to the invention. FIG. 14 is a plan view illustrating an exemplary embodiment of the light guide plate 300 of the backlight assembly in FIG. 13. The display apparatus of the illustrated exemplary embodiment is substantially the same as the display apparatus of the exemplary embodiment in FIGS. 10 and 11, except that a lens array is disposed on the incident surface 310 of the light guide plate 300 for adjusting the emitting angle distribution. Thus, the same numerical reference will be used and the overlapped description will be omitted.

Referring to FIGS. 13 and 14, a lens array 360 separate and discontinuous from a main portion of the light guide plate 200 is on the incident surface 310 of the light guide plate 300 for adjusting the emitting angle distribution of the light which is incident from the first light sources 210. In particular, the lens array 360 is a rectangular plate shape and includes light adjusting patterns 362 having a convex lens shape corresponding to a portion of the first light sources 210. In one exemplary embodiment, for example, one of the light adjusting patterns 362 having the convex lens shape corresponds to the second first light source 210b in the x-direction. Moreover, one of the light adjusting patterns 362 having the convex lens shape also corresponds to the fifth first light source 210e in the x-direction. In the same pattern, the light adjusting patterns 362 are on the incident surface 310 of the light guide plate 300.

The light adjusting patterns 362 adjust emitting angle distribution of the light, which is incident from the first light sources 210b, 210e and 210h to the incident surface 310 according to the light adjusting patterns 362. In particular, the emitting angle distribution of the light, which is incident from the first light sources 210b, 210e and 210h according to the light adjusting patterns 362, is narrowed by the shape of the light adjusting patterns 362. However, the emitting angle distribution of the incident light is sustained absent the light adjusting patterns because the emitting angle distribution is not effected. Thus, the emitting angle distribution could be diversified by the light adjusting patterns selectively on the incident surface 310 of the light guide plate 300 even when the light sources 300 have substantially the same emitting angle distribution.

The lens array 360 is a single unitary and indivisible member which is integrally formed in the illustrated exemplary embodiment. The lens array 360 of the illustrated exemplary embodiment is not limited as described above. The lenses of the light adjusting pattern 362 may be formed separately and individually from a remaining portion of the lens array 360, and the lens array 360 may be formed by assembling the separate lenses. The lenses may be a spherical or an elliptical shape, or may be a convex lens shape.

As described the above, according to exemplary embodiments of the invention, the thickness of the light guide plate is gradually increased from the incident surface to the opposing surface. The opposing surface includes a zigzag pattern, and the backlight assembly includes the first light sources, and the second light sources having the different emitting angle distribution from the first light sources, so that the emitting angle distribution of the backlight assembly may be controlled actively.

Moreover, the light guide plate has a rectangular shape, so that the size of the frame receiving the display apparatus may be effectively reduced and the manufacturing process may be simplified.

Moreover, the light adjusting pattern for adjusting the emitting angle distribution is on the incident surface of the light guide plate, and thus the emitting angle distribution of the backlight assembly may be controlled actively when light sources have the same emitting angle distribution.

In the claims, means-plus-function clauses are intended to cover the structures described herein as performing the recited function and not only structural equivalents but also equivalent structures. Therefore, it is to be understood that the foregoing is illustrative of the invention and is not to be construed as limited to the specific exemplary embodiments disclosed, and that modifications to the disclosed exemplary embodiments, as well as other exemplary embodiments, are intended to be included within the scope of the appended claims. The invention is defined by the following claims, with equivalents of the claims to be included therein.

What is claimed is:

1. A backlight assembly comprising:
a plurality of light sources generating light, the light sources including first light sources, and second light sources having a different emitting angle from the first light sources;
a light guide plate including:
an incident surface to which the light is incident;
an exiting surface which extends from the incident surface and emits the incident light; and
an opposing surface which extends from the exiting surface, opposes the incident surface and meets the exiting surface at a substantially straight line, and a prism sheet which converts light emitted from the light guide plate.

2. The backlight assembly of claim 1,
wherein the opposing surface comprises a zigzag pattern and comprises a greater height than the incident surface

3. The backlight assembly of claim 1,
wherein the prism sheet changes a progressing direction of the light emitted from the light guide plate to be substantially perpendicular to the exiting surface.

4. The backlight assembly of claim 1,
wherein the incident surface comprises a light adjusting pattern corresponding to a portion of the light sources.

5. The backlight assembly of claim 4,
wherein the light adjusting pattern has a trapezoid pillar shape.

6. The backlight assembly of claim 4,
wherein the light adjusting pattern has a spherical shape.

7. The backlight assembly of claim 1,
further comprising a lens array between the incident surface and the light sources and including a light adjusting pattern corresponding to a portion of the light sources.

8. The backlight assembly of claim 7,
wherein the light adjusting pattern has a convex lens shape.

9. The backlight assembly of claim 8,
wherein
the light sources further comprise a plurality of light source groups, and
each of the light source groups comprises at least one of the first light sources, and at least one of the second light sources adjacent to the one first light source.

10. The backlight assembly of claim 1,
wherein
the light sources comprise a plurality of light source groups, and
each of the light source groups comprises at least three light sources adjacent to each other and having a different emitting angle distribution from each other.

11. The backlight assembly of claim 1,
wherein the light guide plate further includes a reflective layer on the opposing surface.

12. The backlight assembly of claim 1,
wherein
the zigzag pattern of the opposing surface forms a zigzag shape on a plane substantially perpendicular to the incident surface and the exiting surface, and
protrusion parts of the zigzag pattern are arranged substantially parallel to the line at which the exiting surface and the opposing surface meet.

13. The backlight assembly of claim 12,
wherein the opposing surface is substantially parallel to the incident surface.

14. The backlight assembly of claim 12,
wherein the opposing surface has a circular arc shape on a plane substantially perpendicular to the incident surface and the exiting surface.

15. The backlight assembly of claim 14,
wherein
the light guide plate further comprises a lower surface opposing the exiting surface; and
a center point of the circular arc of the opposing surface is substantially the same as a meeting point at which an extension line of the exiting surface and an extension line of the lower surface meet at a plane substantially perpendicular to the incident surface and the exiting surface.

16. The backlight assembly of claim 1,
wherein the prism sheet includes a prism pattern on one surface of the prism sheet.

17. The backlight assembly of claim 16,
further comprising a reflective plate under the light guide plate, and
wherein the prism sheet is on the exiting surface, and the prism pattern of the prism sheet faces the exiting surface.

18. The backlight assembly of claim 17,
further comprising a diffusion sheet on the prism sheet, wherein the diffusion sheet diffuses light emitted from the prism sheet.

19. The backlight assembly of claim 16,
wherein
the prism sheet is under the light guide plate, and
the prism sheet further includes a reflective layer on the prism pattern of the prism sheet.

20. The backlight assembly of claim 19,
wherein a surface of the prism sheet not including the prism pattern faces the light guide plate.

21. The backlight assembly of claim 19,
wherein a surface of the prism sheet including the prism pattern faces the light guide plate.

22. The backlight assembly of claim 19,
further comprising a transparent adhesive between the prism sheet and the light guide plate, wherein the transparent adhesive material adheres the prism sheet to the light guide plate, and
wherein a refractive index of the transparent adhesive material is smaller than a refractive index of the light guide plate.

23. The backlight assembly of claim 22, further comprising a diffusion sheet on the light guide plate and diffusing the light emitted from the exiting surface of the light guide plate.

24. A display apparatus comprising:
a backlight assembly comprising:
a plurality of light sources generating light, the light sources including first light sources, and second light sources having a different emitting angle from the first light sources;
a light guide plate including:
an incident surface to which the light is incident;
an exiting surface extended from the incident surface and emitting the incident light; and
an opposing surface which extends from the exiting surface, opposes
the incident surface and meets the exiting surface at a substantially straight line,
a prism sheet which converts the emitted light from the light guide plate, and
a display panel on the backlight assembly and displaying an image by using the light provided from the backlight assembly.

25. The display apparatus of claim 24,
wherein the opposing surface comprises a zigzag pattern and comprises a greater height than the incident surface

26. The display apparatus of claim 24,
wherein the prism sheet changes a progressing direction of the light emitted from the light guide plate to be substantially perpendicular to the exiting surface.

27. The display apparatus of claim 24,
wherein the incident surface comprises a light adjusting pattern corresponding to a portion of the light sources.

28. The display apparatus of claim 24, further comprising a lens array between the incident surface and the light sources and including a light adjusting pattern corresponding to a portion of the light sources.

29. The display apparatus of claim 24, further comprising a light source driving part including:
a first sub light source driving part driving the first light sources, and
a second sub light source driving part driving the second light sources.

30. The display apparatus of claim 24,
wherein
the backlight assembly further comprises a reflective plate under the light guide plate, and
the prism sheet is on the light guide plate.

31. The display apparatus of claim 24,
wherein
the prism sheet is under the light guide plate, and
the prism sheet further includes a reflective layer on the prism pattern of the prism sheet.

32. The display apparatus of claim 31,
further comprising a transparent adhesive material between the prism sheet and the light guide plate, wherein the transparent adhesive material adheres the prism sheet to the light guide plate, and
wherein a refractive index of the transparent adhesive material is smaller than a refractive index of the light guide plate.
